(19) United States
(12) Patent Application Publication
(10) Pub. No.: US 2022/0252096 A1
(43) Pub. Date: Aug. 11, 2022

(54) INSERT COUPLING

(71) Applicant: Robert Varney, Topsfield, MA (US)

(72) Inventor: Robert Varney, Topsfield, MA (US)

(21) Appl. No.: 17/590,589

(22) Filed: Feb. 1, 2022

Related U.S. Application Data
(60) Provisional application No. 63/148,054, filed on Feb. 10, 2021.

(51) Int. Cl. F16B 7/22; F16B 7/18; F16B 39/00

(52) U.S. Cl. CPC F16B 7/22; F16B 39/00; F16B 7/182

(57) ABSTRACT

A system and process for removably, replaceably, and fixedly coupling a member to a structure without the need for adhesives or welding. The member is provided with an insert coupling that makes use of reciprocating catches in the mating region of the insert coupling. The reciprocating catches engage receiving features provided in a hollow end of the structures to couple the structure to the member via the insert coupling. The structure can be uncoupled from the member by disengaging the reciprocating catches of the insert coupling from the receiving features of the hollow end of the structure.

### CROSS-REFERENCE TO RELATED APPLICATION(S)

This application claims priority to, and the benefit of, co-pending U.S. Provisional Application 63/148,054 filed Feb. 10, 2021, for all subject matter common to both applications. The disclosure of said provisional application is hereby incorporated by reference in its entirety.

### FIELD OF THE INVENTION

The present invention relates to couplings suitable for attaching members to structures. In particular, the present invention relates to an insert coupling that can couple a member to a hollow end of a structure in a removable, replaceable, and fixed manner, and without adhesive or welding.

### BACKGROUND

At present, the technique for attaching a coupling/member to a structure includes the use of an epoxy, adhesive, or mechanical fastener. In addition, the attachment of the coupling is permanent in nature, in that it cannot be easily undone and/or removed.

### SUMMARY

There is a need for a system and process for removably, replaceably, and fixedly coupling, joining, or otherwise connecting to structures that does not require adhesives, welds, or complicated or expensive couplings. The present invention is directed toward further solutions to address this need, in addition to having other desirable characteristics.

The technology of the present invention uses no adhesives, welds, or complex and expensive fasteners. The system and process allow a member to be coupled to a structure in a removable, replaceable, and fixed manner but when coupled the coupling performs as if it were a permanent coupling, such as via adhesive or weld. The removal of material in strategic areas of the hollow end of a structure allows a coupling insert system to attach the structure.

In accordance with example embodiments of the present invention, an insert coupling for removable, replaceable, and fixed coupling of a member to a hollow end of a structure having a receiving feature is provided. The insert coupling includes a body and at least one mating end catch. The body has a mating end region having a mating end, a second end at an opposite end of the body from the mating end region and the mating end, and at least one body sidewall therebetween structurally connecting the mating end region and mating end with the second end, thereby forming the member. The at least one mating end catch is disposed in the at least one body sidewall at the mating end region and reciprocates by extending outward from the body to an engaged position and retracting inward to the body to a dis-engaged position. The at least one mating end catch is structurally sized and positioned in such a way that engages the receiving feature of the hollow end of the structure when the mating end is placed in a predetermined coupled position and orientation inside the hollow end of the structure with the at least one mating end catch in the engaged position into the receiving feature. The insert coupling can be removably, replaceably, and fixedly coupled to the hollow end of the structure without requiring adhesive or welding.

In accordance with aspects of the invention, the body comprises machined aluminum.

In accordance with aspects of the invention, when the at least one mating end catch engages the receiving feature of the hollow end of the structure in the engaged position, the at least one mating end catch is sized and configured in such a way that it is flush with an outer wall of the hollow end of the structure at the receiving feature.

In accordance with aspects of the invention, the insert coupling further includes a plurality of mating end catches.

In accordance with aspects of the invention, the at least one mating end catch includes a recess in the sidewall of the mating end region, and a spring-loaded reciprocatable pin disposed within the recess. In some such aspects, the pin has a generally triangular cross-section.

In accordance with aspects of the invention, the receiving feature comprises an aperture.

In accordance with aspects of the invention, the mating end region has a total outer circumference and the hollow end has a total inner circumference, and a total gap tolerance between the total outer circumference of the mating end region and the total inner circumference of the hollow end is less than about 0.010 inches. In accordance with certain aspects of the invention the total gap tolerance between the total outer circumference of the mating end region and the total inner circumference of the hollow end is between about 0.002 and about 0.004 inches.

In accordance with aspects of the invention, the insert coupling, the structure, or both, are formed of a carbon fiber composite material.

In accordance with aspects of the invention, the body further includes one or more gaskets in proximity to the second end.

In accordance with aspects of the invention, the insert coupling further includes securing means for securing the at least one mating end catch in the body of the insert coupling. In some such aspects, the securing means comprises one of more screw fasteners. In other aspects, the securing means includes a locking screw and a receiving member. The locking screw extends from the at least one mating end catch through the body of the insert coupling toward the second end of the insert coupling. The receiving member extends from the second end though the body and configured to engage and secure the locking screw.

In accordance with example embodiments of the present invention, a method of implementing removable, replaceable, and fixed coupling of a member having an insert coupling to a hollow end of a structure without requiring adhesive or welding is provided. The method involves providing a structure having a t hollow end with a receiving feature, providing a member having an insert coupling as described herein, retracting the at least one mating end catch to the dis-engaged position, placing the mating end inside the hollow end of the structure, aligning the receiving feature of the hollow end with the at least one mating catch of the mating end region, and extending the at least one mating end catch into the receiving feature to the engagement position. In the engaged position, the insert coupling is removably, replaceably, and fixedly coupled with the structure without requiring adhesive or welding.

In accordance with aspects of the present invention, the method further includes uncoupling the insert coupling from the hollow end of the structure. The uncoupling involves retracting the at least one mating catch to a disengaged position and extracting the mating end from the hollow end, in such a way that disengages the mating end from the receiving feature of the hollow end of the structure.

### BRIEF DESCRIPTION OF THE FIGURES

These and other characteristics of the present invention will be more fully understood by reference to the following detailed description in conjunction with the attached drawings, in which:

FIG. 1 is an example insert coupling in accordance with an embodiment of the present invention;

FIG. 2 is a transparent isometric view of an insert coupling in accordance with an embodiment of the present invention;

FIG. 3 is another transparent isometric view of an insert coupling in accordance with an embodiment of the present invention;

FIG. 4 is an isometric view of an example insert coupling coupled with a structure in accordance with an embodiment of the present invention;

FIG. 5 is an isometric view of an insert coupling wherein the body of the member extends beyond the first mating end region in accordance with an embodiment of the present invention;

FIG. 6 is an isometric view of an example insert coupling coupled with a structure wherein the body of the member extends beyond the first mating end region and from the structure in accordance with an embodiment of the present invention;

FIG. 7 is an embodiment of an insert coupling wherein the body of the member extends beyond the first mating end region in accordance with an embodiment of the present invention;

FIG. 8 depicts the insert coupling of FIG. 7 coupled with a structure wherein the body of the member extends beyond the first mating end region and from the structure in accordance with an embodiment of the present invention;

FIG. 9 is an isometric view of another embodiment of example insert coupling in accordance with an embodiment of the present invention;

FIG. 10 is close-up transparent isometric view of the insert coupling of FIG. 9 in accordance with an embodiment of the present invention;

FIG. 11 is an example flow diagram of a method for coupling a member to a structure using the insert coupling in accordance with embodiments of the present invention;

FIG. 12 is an example flow diagram depicting the steps involved in engaging a hollow end of a structure with an insert coupling in accordance with embodiments of the present invention; and

FIG. 13 is an example flow diagram depicting the steps involved in disengaging an insert coupling from a hollow end of a structure in accordance with embodiments of the present invention.

### DETAILED DESCRIPTION

An illustrative embodiment of the present invention relates to an insert coupling system and process that can removably, replaceably, and fixedly couple a member to a hollow end of a structure without the need for adhesives or welding or complex expensive fasteners. The insert coupling makes use of reciprocating catches in the end regions of the member. The reciprocating catches engage receiving features provided in the hollow end of the structure to couple the structure to the member. The member can be uncoupled by disengaging the reciprocating catches of the insert coupling from the receiving features of the hollow end of the structure as desired. The member can be a permanent part of the insert coupling body, an extension thereof, and/or a separately removable and replaceable structure from the insert coupling body.

Applicant notes that throughout this disclosure the inventive universal coupling is described and depicted as removably, replaceably, and fixedly coupling other structures together. For purposes of clarity, the following explanation is offered as to what is mean by each of these terms. Removable and removably are utilized in accordance with their conventional meanings indicating the universal coupling, once installed, can be uninstalled and removed without causing damage to the structures that had been coupled together. Replaceable and replaceably are utilized in accordance with their conventional meanings indicating the universal coupling can be swapped out with other instances of the coupling and subsequently installed or reinstalled to couple the structures together without causing damage to the structures. Fixed and fixedly are utilized in accordance with their conventional meanings indicating that when the universal coupling is in place coupled to a structure, the coupling is not loose, or replete with gaps that cause the coupling and the structure to perceptibly move relative to each other, but instead the coupling appears in a locked, rigid, tight, anchored, firm, immobile, and stable manner more similar to a weld or adhesive-based coupling process.

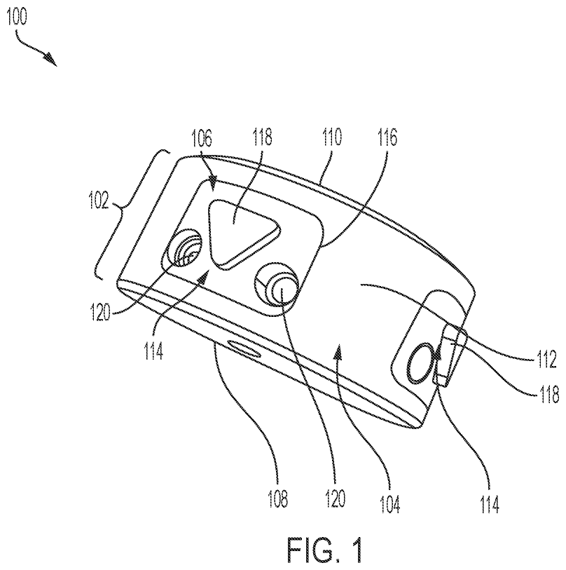

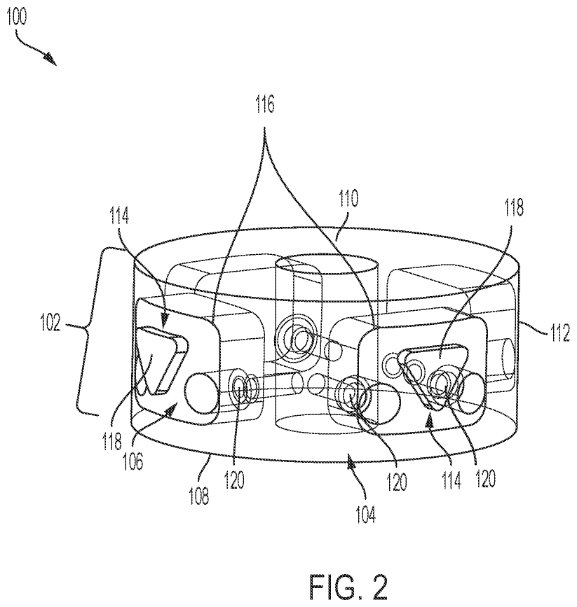

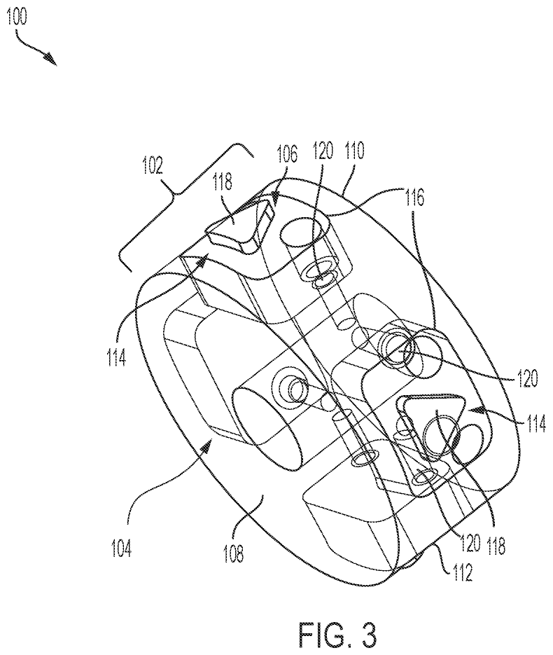

FIGS. 1 through 13 wherein like parts are designated by like reference numerals throughout, illustrate an example embodiment or embodiments of a universal coupling and process for coupling structures without requiring adhesive or welding, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIGS. 1-4 depict one embodiment of an insert coupling 102 and its use in accordance with one embodiment. In this embodiment, the member 100 to be coupled by the insert coupling 102 is an endcap that is part of and/or extension of the insert coupling 102 itself. The insert coupling 102 as seen in FIGS. 1-4 comprises a body 104 having a mating end region 106 having a mating end 108, a second end 110, and at least one body sidewall 112. The second end 110 is at the opposite end of the body 104 from the mating end region 106 and the mating end 108. The at least one body sidewall 112 spans therebetween and structurally connects the mating end region 106 and mating end 108 with the second end 110.

In certain embodiments, the body 104 of the insert coupling 102 (as well as member 100) can be formed of metal or alloy. In some such embodiments, the body 104 is formed of machined aluminum. In some embodiments the insert coupling 102 in all or in part may be constructed of carbon fiber composite material. The shape, configuration, and size of the insert coupling 102 depends on the shape, configuration, and size of the hollow end of the structure the member 100 is being coupled to. In the example of FIGS. 1-4, the body 104 has a cylindrical shape with a circular cross-section and a singular instance of the at least one body sidewall 112. Other cross-sectional shapes may require additional instances of the at least one body sidewalls 112. For example, a generally triangular cross-sectional shape may involve three instances of the at least one body sidewalls 112. A square cross-sectional shape may involve four instances of the at least one body sidewalls 112. Other possible shapes and sidewall numbers will be apparent to one skilled in the art given the benefit of this disclosure.

At least one mating end catch 114 is disposed in the at least one body sidewall 112 at the mating end region 106. The at least one mating end catch 114 reciprocates by extending outward from the body 104 to an engaged position and retracting inward to the body 104 to a dis-engaged position. In certain embodiments, as seen in FIGS. 1-3, there are a plurality of mating end catches 114 disposed around the body 104 in the mating end region 106. The number and configuration of first mating end catches 114 can vary based on the application.

In the embodiment of FIGS. 1-3, the mating end catch 114 comprises a recess 116 in the sidewall 112 of the mating end region 106 and a spring-loaded reciprocatable pin 118 disposed within the recess 116. In the example of FIGS. 1-3, the recess 116 is substantially rectangular in shape while the pin 118 is substantially or generally triangular in shape (i.e., resembling a triangle but with rounded corners). However, the recess 116 and pin 118 can have any number of compatible shapes and configurations as will be apparent to one skilled in the art given the benefit of this disclosure. In certain embodiments the spring-loaded reciprocatable pin 118 is part of an assembly that is secured in the recess 116 using one or more fasteners such as screw fasteners 120. This configuration allows the mating end catch 114 to be swapped out or replaced as necessary for a particular application.

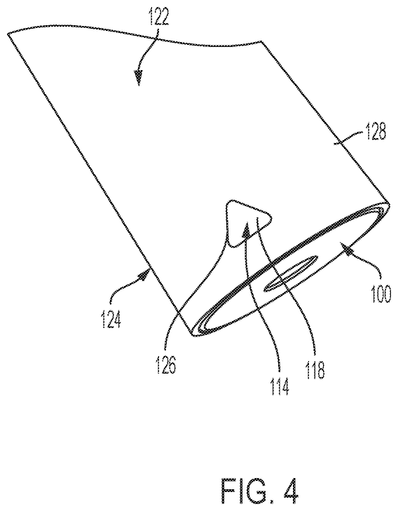

In FIG. 4 the end cap member 100 of FIGS. 1-3 has been coupled with a hollow end 124 of a structure 122 having one receiving feature 126 using an insert coupling 102. The at least one mating end catch 114 is structurally sized and positioned in such a way that engages the first receiving feature 126 of the hollow end 124 of the structure 122 when the mating end 108 is placed in a predetermined coupled position and orientation inside the hollow end 124 of the structure 122 with the at least one mating end catch 114 in the engaged position into the first receiving feature 126.

In some embodiments, the first receiving feature 126 comprises a first aperture. In certain embodiments, when the at least first mating end catch 114 engages the first receiving feature 126 of the hollow end 124 of the structure 122 in the engaged position, the at least one mating end catch 114 is sized and configured in such a way that it is flush with an outer wall 128 of the structure 122 at the receiving feature 126. The mating end region 106 of the insert coupling 102 has a total outer circumference and the hollow end 124 of the structure 122 has a total inner circumference. In certain embodiments, the total gap tolerance between the total outer circumference of the mating end region 106 and the total inner circumference of the hollow end 124 is less than about 0.010 inches.

To test the operation of the coupling 102, testing samples with various gap tolerances between the total outer circumference of the mating end region 106 and the total inner circumference of the hollow end 124 were made. A first set of test samples had a gap tolerance to be between about 0.002 and about 0.004 inches. The coupling of the coupling 102 to a hollow end 124 of a structure 122 with this gap tolerance performed within acceptable parameters to provide the desired removably, replaceably, and fixedly coupling functionality. Another set of samples had a gap tolerance of less than about 0.010 inches were made and tested. The coupling of the coupling 102 to a hollow end 124 of a structure 122 with this test set also performed within acceptable parameters to provide the desired removably, replaceably, and fixedly coupling functionality.

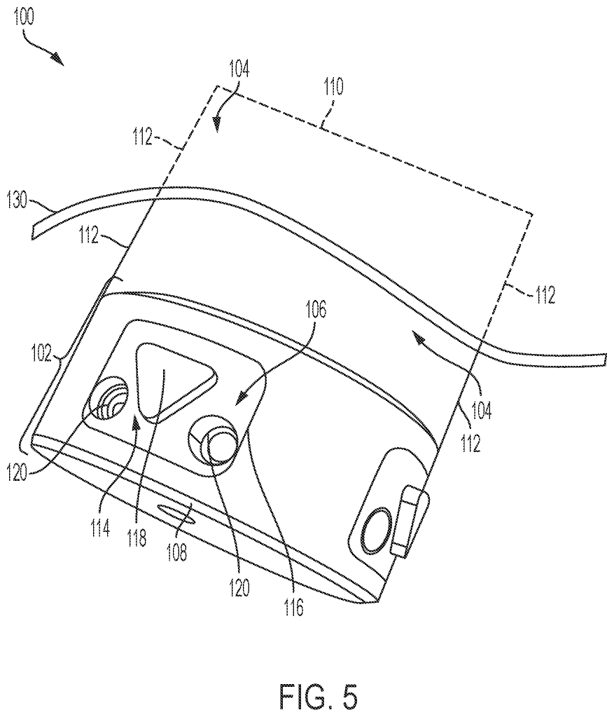

While in the example of FIGS. 1-4, the member 100 consists primarily of the insert coupling 102, it should be understood that the member 100 being coupled to the structure 122 by the insert coupling 102 can have any number of shapes, configurations, features, and/or functionality. FIGS. 5-10 show various example embodiments wherein the body 104 of the member 100 extends beyond the insert coupling 102. In FIG. 5 the insert coupling 102 has a similar configuration as the example of FIGS. 1-3 but body 104 extend from the mating end region 106 such that the second end 110 is not located in close proximity to the mating end as indicated by break lines 130. The shape, configuration, features, and/or functionality of the member is dependent on the type of member 100 that is being coupled to the structure 122 using the insert coupling102. Examples of possible members 100 attachable via the insert coupling 102 include, but are not limited to any type of bracket, fixture, tool, or other device that would be desirable to removably, replaceably, and fixedly coupled to the structure 122 without requiring adhesives, welding, or other fasteners. In certain embodiments, the insert coupling 102 is formed as part of the member 100. In other embodiments the insert coupling 102 is attached to the member 100 via adhesives or fasteners.

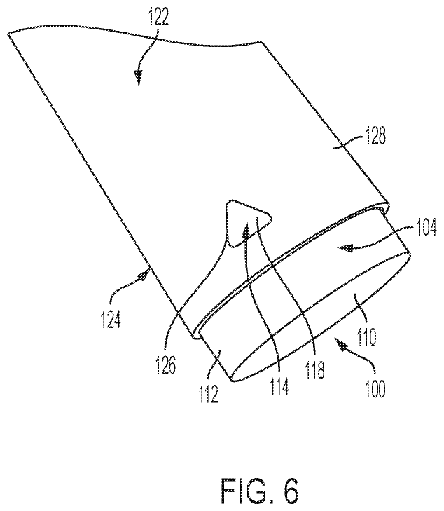

In FIG. 6 a member 100 such as shown in FIG. 5 has been coupled with a hollow end 124 of a structure 122 having one receiving feature 126 using an insert coupling 102. Here the body 104 of the member 100 extends beyond the insert coupling 102 and hollow end 124 of the structure 122. It should be understood that the second end 110 could be any distance from the insert coupling with the body 104 having any number of shapes, configurations, features, and or functionality as dictated by the type of member 100 being coupled via the insert coupling 102.

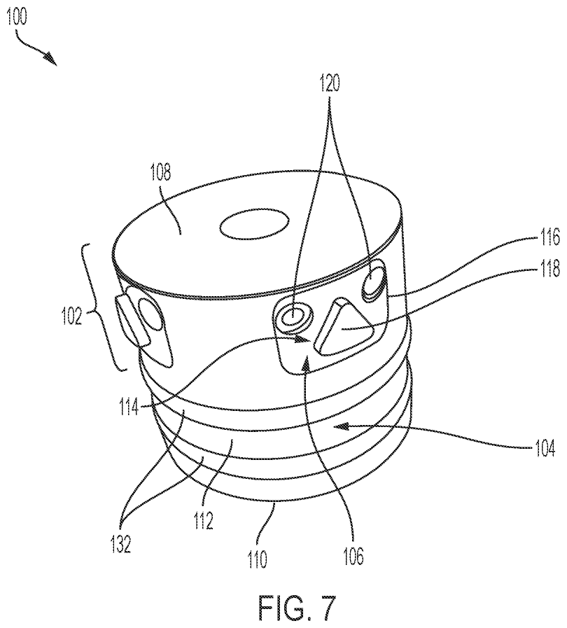

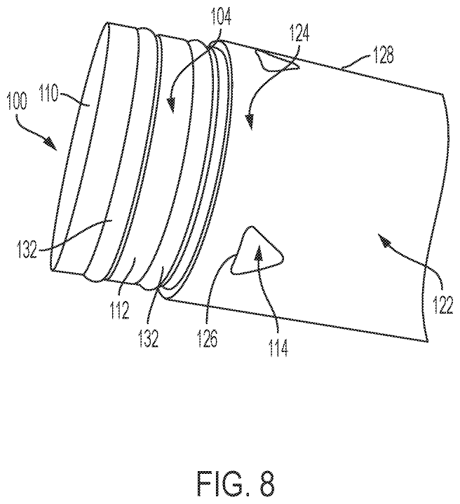

FIGS. 7-8 depicts an embodiment wherein the body 104 extending beyond the insert coupling is provided with one or more gaskets 132 in proximity to the second end 110 allowing for a fluid-tight and/or friction fit coupling with a receiving member configured to receive at least a portion of the body 104. FIG. 7 depicts the member 100 in isolation having one or more gaskets 132 in proximity to the second end 110. FIG. 8 depicts the member of FIG. 7 coupled with a hollow end 124 of a structure 122 having one receiving feature 126 using an insert coupling 102. Here the one or more gaskets 132 on the body 104 extending beyond the insert coupling 102 and hollow end 124 of the structure 122 allows for a fluid-tight and/or friction coupling with a receiver configured to receive least a portion of the body 104 of the member 100. For example, the body 104 or portion of the body 104 could be received by or coupled with another hollow end 124 of a structure 122 or a socket configured to receive at least a portion of the body 104 of member 100.

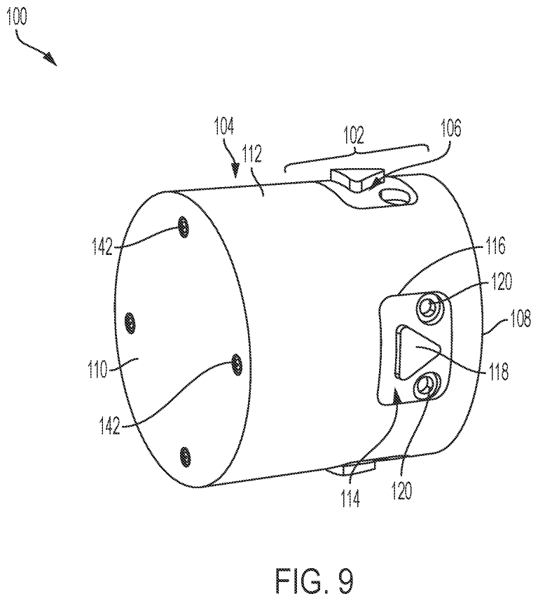

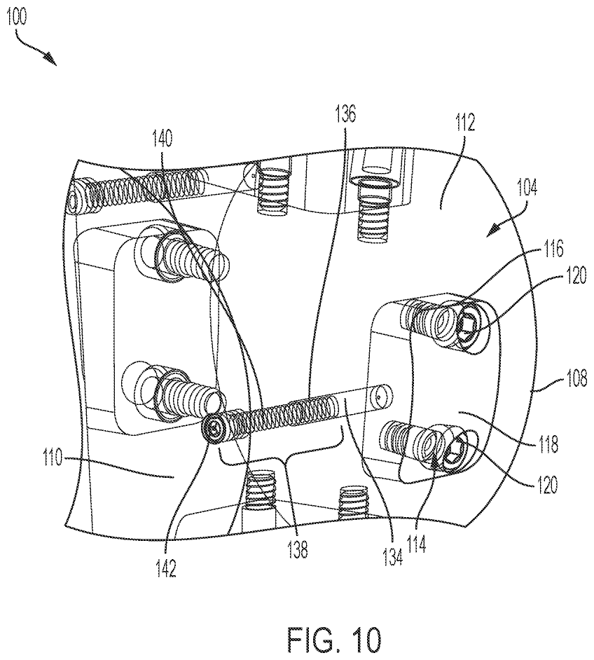

FIGS. 9-10 depict another embodiment having an additional means for securing the mating end catch 114 in the recess 116 of the body 104 of the insert coupling 102. In this example, the mating end catch 114 is provided with a locking screw 134 or other securing means, that extends from the mating end catch 114 through a cavity or passage 136 in the body 104 of the member 100 toward an end of the member 100. In this example, the locking screw 134 (and passage 136) extend through the body 104 toward the second end 110. It should be understood however, that the locking screw 134 (and passage 136) could also extend toward the mating end 108. The end of the member 100 the locking screw extends toward (in this example, the mating end 108) is provided with a corresponding receiving member 138 such as a retaining nut or cap configured to engage and secure the locking screw 134. In the depicted example, the body 140 of receiving member 138 extends into the passage 136 and has a threaded interior configured to mate with the threads of the locking screw 134. The head 142 of the securing member 138 is configured to receive a screwdriver or socket to allowing the receiving member 138 to be rotated to engage the locking screw 134. By engaging and securing the locking screw 134 with the receiving member 138, the mating end catch 114 is secured in the body 104 of the member. In certain embodiments, such means for securing the mating end catch 114 may be used in conjunction with other securing means such as the fastening screws 120 previously discussed.

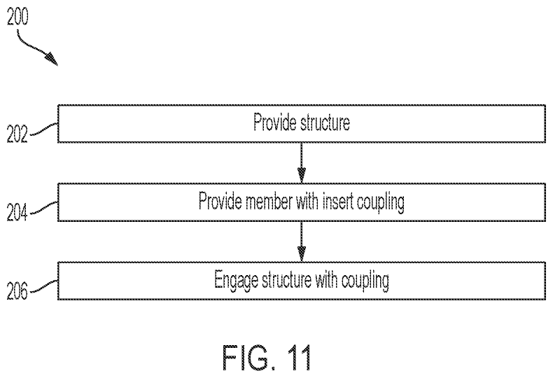

FIG. 11 depicts a flow chart of an example method 200 for removably, replaceably, and fixedly coupling a member 100 to a hollow end 124 of a structure 122 having a receiving feature 126 without requiring adhesive or welding using an insert coupling 102. The first step of the method is providing a structure 122 having a hollow end with a receiving feature 126 (Step 202). A member 100 having an insert coupling 102 as set forth and described herein is then provided (Step 204). The mating end 108 is then placed inside the hollow end 124 of the structure 122 and the at least one receiving feature 126 of the hollow end 124 of the structure 122 is engaged with the at least one mating end catch 114 of the first mating end region 106 (Step 206). This results in the removable, replaceable, and fixed coupling of the member 100 with the hollow end 124 of the structure 122 without requiring adhesive or welding.

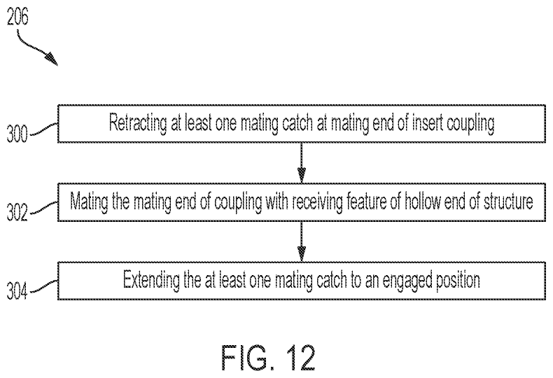

In certain embodiments, engaging a receiving feature 126 with a mating end catch 114 (steps 206) can involve additional steps. An example of this is shown in FIG. 12. Here first additional step is retracting the at least one mating end catch 114 to a disengaged position (Step 300). Then, the mating end 108 is mated with a receiving feature 126 of the hollow end 124 of the structure 122, wherein the structure 122 is in a predetermined coupled position and orientation (Step 302). The at least one mating end catch 114 is then extended to an engaged position (step 304).

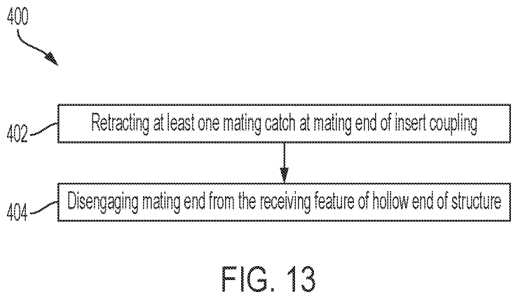

As the coupling provided by the insert coupling 102 is removable and replaceable, certain embodiments may require the uncoupling of member 100. An example method 400 of how this can be accomplished is shown in FIG. 13. The first step is retracting any mating end catches 114 of the insert coupling 102 (Step 402). The mating end 108 is then disengaged from the receiving feature 126 of hollow end 124 of the structure 122 (Step 404).

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. An insert coupling for removable, replaceable, and fixed coupling of a member to a hollow end of a structure having a receiving feature, the insert coupling comprising:
a body having a mating end region having a mating end, a second end at an opposite end of the body from the mating end region and the mating end, and at least one body sidewall therebetween structurally connecting the mating end region and mating end with the second end, thereby forming the member; and
at least one mating end catch disposed in the at least one body sidewall at the mating end region, and which reciprocates by extending outward from the body to an engaged position and retracting inward to the body to a dis-engaged position;
wherein the at least one mating end catch is structurally sized and positioned in such a way that engages the receiving feature of the hollow end of the structure when the mating end is placed in a predetermined coupled position and orientation inside the hollow end of the structure with the at least one mating end catch in the engaged position into the receiving feature; and
wherein the insert coupling is removably, replaceably, and fixedly coupled to the hollow end of the structure without requiring adhesive or welding.

2. The insert coupling of claim 1, wherein the body comprises machined aluminum.

3. The insert coupling of claim 1, wherein when the at least one mating end catch engages the receiving feature of the hollow end of the structure in the engaged position, the at least one mating end catch is sized and configured in such a way that it is flush with an outer wall of the hollow end of the structure at the receiving feature.

4. The insert coupling of claim 1, further comprising a plurality of mating end catches.

5. The insert coupling of claim 1, wherein the at least one mating end catch comprises:
a recess in the sidewall of the mating end region; and
a spring-loaded reciprocatable pin disposed within the recess.

6. The insert coupling of claim 5, wherein the pin has a generally triangular cross-section.

7. The insert coupling of claim 1, wherein the receiving feature comprises an aperture.

8. The insert coupling of claim 1, wherein the mating end region has a total outer circumference and the hollow end has a total inner circumference, and a total gap tolerance between the total outer circumference of the mating end region and the total inner circumference of the hollow end is less than about 0.010 inches.

9. The insert coupling of claim 1, wherein the mating end region has a total outer circumference and the hollow end has a total inner circumference, and a total gap tolerance between the total outer circumference of the mating end region and the total inner circumference of the hollow end is less than between about 0.002 and about 0.004 inches.

10. The insert coupling of claim 1, wherein the insert coupling, the structure, or both, are formed of a carbon fiber composite material.

11. The insert coupling of claim 1, wherein the body further includes one or more gaskets in proximity to the second end.

12. The insert coupling of claim 1, further comprising securing means for securing the at least one mating end catch in the body of the insert coupling.

13. The insert coupling of claim 12, wherein the securing means comprises one of more screw fasteners.

14. The insert coupling of claim 12, wherein the securing means comprises:
a locking screw extending from the at least one mating end catch through the body of the insert coupling toward the second end of the insert coupling;
a receiving member extending from the second end though the body and configured to engage and secure the locking screw.

15. A method of implementing removable, replaceable, and fixed coupling of a member having an insert coupling to a hollow end of a structure without requiring adhesive or welding, the method comprising:
providing a structure having a t hollow end with a receiving feature;
providing a member having an insert coupling comprising:
a body having a mating end region having a mating end, a second end at an opposite end of the body from the mating end region and the mating end, and at least one body sidewall therebetween structurally connecting the mating end region and mating end with the second end, thereby forming the member;
at least one mating end catch disposed in the at least one body sidewall at the mating end region, and which reciprocates by extending outward from the body to an engaged position and retracting inward to the body to a dis-engaged position;
wherein the at least one mating end catch is structurally sized and positioned in such a way that engages the receiving feature of the hollow end of the structure when the mating end is placed in a predetermined coupled position and orientation inside the hollow end of the structure with the at least one mating end catch in the engaged position into the receiving feature;
retracting the at least one mating end catch to the dis-engaged position;
placing the mating end inside the hollow end of the structure;
aligning the receiving feature of the hollow end with the at least one mating catch of the mating end region; and
extending the at least one mating end catch into the receiving feature to the engagement position;
wherein in the engaged position the insert coupling is removably, replaceably, and fixedly coupled with the structure without requiring adhesive or welding.

16. The method of claim 15, further comprising uncoupling the insert coupling from the hollow end of the structure, the uncoupling comprising:
retracting the at least one mating catch to a disengaged position; and
extracting the mating end from the hollow end, in such a way that disengages the mating end from the receiving feature of the hollow end of the structure.

17. The method of claim 15, wherein the insert coupling, the structure, or both, are formed of a carbon fiber composite material.
